(19) United States
(12) Patent Application Publication
(10) Pub. No.: US 2012/0235337 A1
(43) Pub. Date: Sep. 20, 2012

(54) CLAMPING MECHANISM WITH DETACHABLE POSITION MEMBER

(75) Inventors: XIAO-BING XU, Shenzhen City (CN); SHAN-YAN XIA, Shenzhen City (CN); ZHI-WEN WANG, Shenzhen City (CN); QING-SONG WEN, Shenzhen City (CN)

(73) Assignees: HON HAI PRECISION INDUSTRY CO., LTD., New Taipei (TW); FU TAI HUA INDUSTRY (SHENZHEN) CO., LTD., ShenZhen City (CN)

(21) Appl. No.: 13/290,006

(22) Filed: Nov. 4, 2011

(30) Foreign Application Priority Data
Mar. 14, 2011 (CN) 201110060350.3

(51) Int. Cl. B23Q 3/06

(52) U.S. Cl. 269/254 R

(57) ABSTRACT

A clamp mechanism includes a support plate, a frame, a positioning member, a resisting member, an operating assembly. The support plate defines an assembly hole. The frame is fixed to the support plate, and defines a positioning groove and a sliding groove. The positioning member extends through the assembly hole of the support plate, and received in the positioning groove. The operating assembly is connected to the resisting member. The resisting member is movably received in the sliding groove and opposite to the positioning member. The sliding groove has a first end adjacent to the positioning member and a second end away from the positioning member, such that the operating assembly drives the resisting member to move in the sliding groove from the second end to the first end, thereby clamping the positioning member in the positioning groove of the frame.

### BACKGROUND

1. Technical Field

The present disclosure generally relates to clamping mechanisms, and particularly, to a clamping mechanism having a detachable positioning member.

2. Description of the Related Art

A workpiece is usually positioned on a machine tool by a clamp mechanism for a machining process. A clamp mechanism generally includes a support plate, a fastening member, and a driving member for driving the fastening member to move. The support plate is assembled with a plurality of positioning pins, and the workpiece correspondingly defines a plurality of positioning holes. In use, the workpiece is positioned on the support plate with the positioning pins engaging in the positioning holes. The driving member drives the fastening member to move until the fastening member resists the workpiece. Therefore, the workpiece is clamped between the fastening member and the support plate. However, because the machining precision of the positioning pins is limited, some of the positioning pins cannot exactly match the positioning holes of the workpiece, and thus the workpiece may be scratched by the positioning pins.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a clamping mechanism clamping a workpiece.

FIG. 2 is an exploded, isometric view of the clamping mechanism together with the workpiece of FIG. 1, in which the clamping mechanism includes a frame and a resisting member.

FIG. 3 is a side view of the frame assembled with the resisting member of FIG. 2.

### DETAILED DESCRIPTION

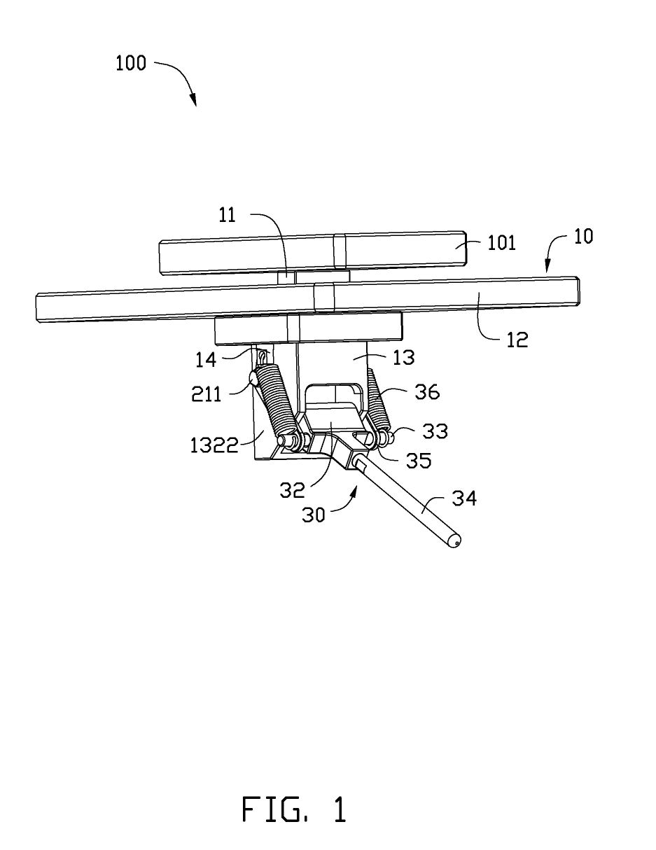

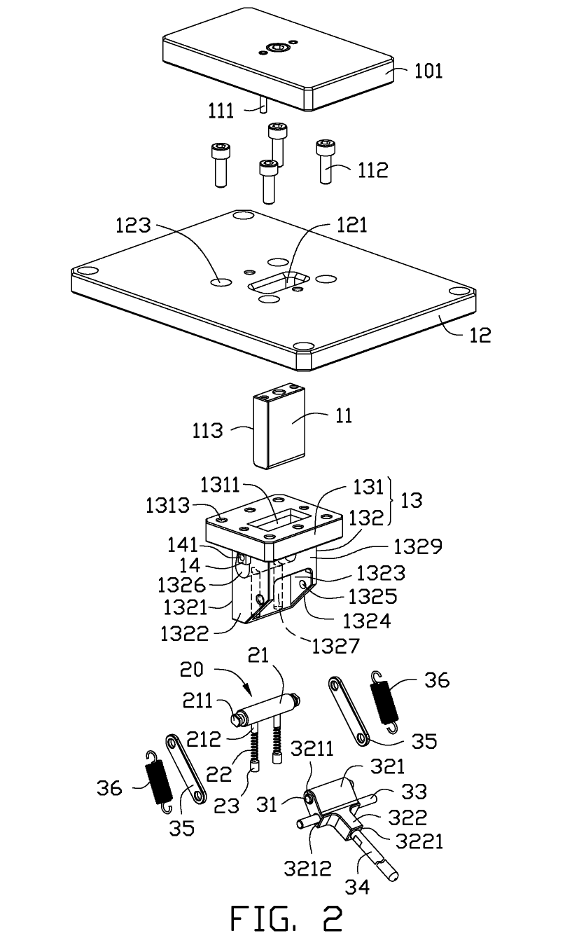

Referring to FIGS. 1 and 2, an embodiment of a clamp mechanism 100 for clamping a workpiece 101 includes a positioning assembly 10, a fastening assembly 20 received in the positioning assembly 10, and an operating assembly 30 connected to the fastening assembly 20.

The positioning assembly 10 includes a positioning member 11, a support plate 12 extended through by the positioning member 11, a frame 13 fixed to the support plate 12, and two connecting members 14 fixed on opposite sides of a frame 13. In the illustrated embodiment, the positioning member 11 is connected to the workpiece 101 via a connecting pin 111. Each connecting member 14 defines a connecting hole 141.

The support plate 12 defines an assembly hole 121 in a center portion thereof, and a plurality of through holes 123 around the assembly hole 121. The positioning member 11 is substantially rectangular, and having one end thereof extending through the assembly hole 121 and connected to the workpiece 101, and the other end thereof received in the frame 13. The positioning member 11 has a side resisting wall 113 to be resisted by the fastening assembly 20.

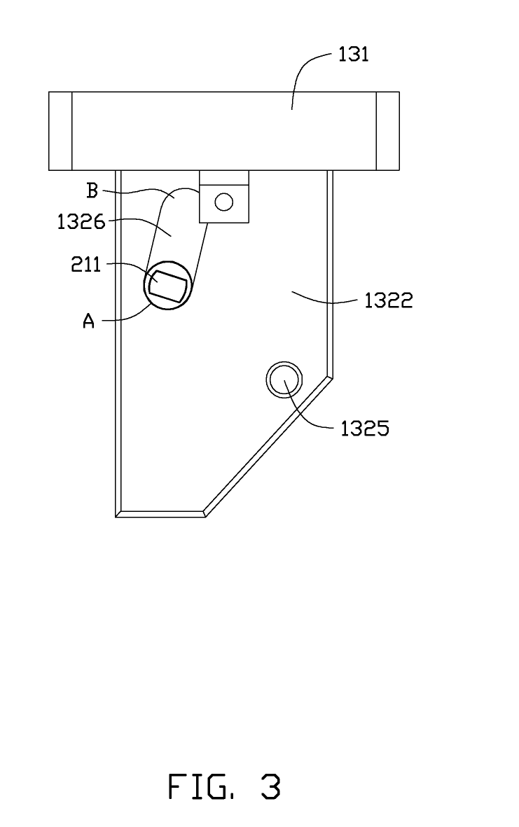

The frame 13 is fixed to a side of the support plate 12 away from the workpiece 101, and includes a fixing portion 131 and a receiving portion 132 connected to the fixing portion 131. The fixing portion 131 defines a positioning groove 1311 for receiving the positioning member 11, and a plurality of fixing holes 1313 around the positioning groove 1311. The receiving portion 132 includes a first side plate 1321, two second side plates 1322 substantially perpendicularly connected to opposite ends of the first side plate 1321, and a third side plate 1329 connecting the second side plates 1322, and parallel to the first side plate 1321. The third side plate 1329 is shorter than the first side plate 1321. The first side plate 1321, the second side plates 1322, and the third side plate 1329 cooperatively defines a receiving groove 1323 communicating with the assembly hole 121. Each second side plate 1322 forms a sloping resisting surface 1324 at an end thereof away from the support plate 12, and defines a connecting hole 1325 adjacent to the resisting surface 1324. Referring to FIG. 3, each second side plate 1322 further defines a sliding groove 1326, which has a first end A adjacent to the first side plate 1321 and a second end B adjacent to the third side plate 1329. The first side plate 1321 defines two receiving holes 1327 arranged side by side and communicating with the sliding groove 1326.

The fastening assembly 20 includes a resisting member 21, two elastic members 22, and two support members 23. The resisting member 21 is substantially cylindrical, and forms two first connecting portions 211 on opposite ends thereof. The resisting member 21 further forms two second connecting portions 212 in the cylindrical surface of the resisting member 21. The elastic members 22 connect the support members 23 to the second connecting portions 212 correspondingly. In the illustrated embodiment, the elastic members 22 are a plurality of compression springs.

The operating assembly 30 includes a pivot shaft 31, a main body 32 rotatably sleeved on the pivot shaft 31, a rotatable shaft 33 extending through the main body 32, an operating pole 34 connected to the main body 32, two connecting pieces 35 and two elastic members 36. In the illustrated embodiment, the elastic members 36 are a plurality of tension springs.

The main body 32 includes a first part 321 and a second part 322 slantingly connected to the first part 321. The first part 321 is wider than the second part 322. The first part 321 defines a pivot hole 3211 in an end thereof away from the second part 322 for receiving the pivot shaft 31, and a connecting hole 3212 in an end thereof adjacent to the second part 322 for receiving the rotatable shaft 33. The second part 322 defines an assembly hole 3221, in which the operating pole 34 is fixed.

In assembly of the clamp mechanism 100, the support plate 12 is fixed to the frame 13 via a plurality of fixing members 112, and then the positioning member 11 extends through the assembly hole 121 of the support plate 12, and is positioned in the positioning groove 1311 of the frame 13. The resisting member 21 is positioned in the sliding groove 1326, with the second connecting portions 212 engaging in the receiving holes 1327. The elastic members 22 and the support members 23 are positioned in the receiving holes 1327 of the frame 13 in turns. Opposite ends of the pivot shaft 31 are received in the connecting holes 1325 of the second side plates 1322, respectively. The connecting pieces 35 are positioned on opposite sides of the frame 13, and each of the connecting pieces 35 connects one corresponding first connecting portion 211 to the rotatable shaft 33. The elastic members 36 are positioned on opposite sides of the frame 13, and each of the elastic members 36 connects one corresponding connecting member 14 to the rotatable shaft 33.

Referring to FIGS. 1 through 3, in use, the workpiece 101 is positioned to the positioning member 11 via the connecting pin 111, and attached to the support plate 12. The operating pole 34 is rotated towards the support plate 12, and then the elastic members 36 and the connecting pieces 35 pull the resisting member 21 to move to the first end A of the sliding groove 1326, that is, the resisting member 21 moves towards the first side plate 1321. Therefore, the positioning member 11 is clamped between the resisting member 21 and the first side plate 1321. As a result, the workpiece 101 is positioned on the clamp mechanism 100.

When the operating pole 34 is rotated towards the support plate 12, the elastic members 36 and the connecting pieces 35 then pull the resisting member 21 to move to the second end B of the sliding groove 1326, that is, the resisting member 21 is moved farther away from the first side plate 1321. Therefore, the positioning member 11 can be taken out of the frame 13, and the workpiece 101 is removed from the positioning member 11.

The clamp mechanism 100 employs the positioning member 11 to first position the workpiece 101, and then clamps the positioning member 11 through adjusting a distance between the resisting member 21 and the first side plate 1321, thereby further positioning the workpiece 101 on the support plate 12. Therefore, the resisting member 21 is not directly pushing on the workpiece 101, such that the workpiece 101 avoids being scratched by the resisting member 21.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A clamp mechanism, comprising:
a support plate defining an assembly hole;
a frame fixed to the support plate, the frame defining a positioning groove;
a positioning member extending through the assembly hole of the support plate, and received in the positioning groove;
a resisting member; and
an operating assembly connected to the resisting member;
wherein the frame further defines a sliding groove; the resisting member is movably received in the sliding groove and opposite to the positioning member, the sliding groove has a first end thereof adjacent to the positioning member and a second end thereof away from the positioning member, such that the operating assembly drives the resisting member to move in the sliding groove from the second end to the first end, thereby clamping the positioning member in the positioning groove of the frame.

2. The clamping mechanism of claim 1, wherein the frame comprises a fixing portion and a receiving portion connected to the fixing portion, the positioning groove is defined in the fixing portion.

3. The clamping mechanism of claim 1, wherein the receiving portion comprises a first side plate, two second side plates substantially perpendicularly connected to opposite ends of the first side plate, and a third side plate connecting the second side plates, and parallel to the first side plate, the third side plate is shorter than the first side plate, and the second side plates define the sliding grooves.

4. The clamping mechanism of claim 1, wherein the operating assembly comprises a pivot shaft rotatably connected to the frame, a main body rotatably sleeved on the pivot shaft, a rotatable shaft extending through main body, and an operating pole connected to the main body.

5. The clamping mechanism of claim 4, wherein the main body comprises a first part and a second part, the second part is configured and connected at a slant angle to the first part, the pivot shaft and the rotatable shaft extend through the first part, and the operating pole is fixed to the second part.

6. The clamping mechanism of claim 4, wherein the operating assembly further comprises two connecting pieces positioned on opposite sides of the frame, and each connecting piece connects the resisting member to the rotatable shaft.

7. The clamping mechanism of claim 6, wherein the operating assembly further comprises two elastic members positioned on opposite sides of the frame, and each elastic member connects the resisting member to the rotatable shaft.

8. The clamping mechanism of claim 7, wherein the elastic members are a plurality of tension springs.

9. The clamping mechanism of claim 1, wherein the resisting member is substantially cylindrical.

10. A clamp mechanism, comprising:
a support plate defining an assembly hole;
a frame fixed to the support plate;
a positioning member extending through the assembly hole of the support plate, and received in the frame;
a resisting member movably connected to the frame and opposite to the positioning member; and
an operating assembly connected to the resisting member, wherein the operating assembly drives the resisting member to move in the frame and towards the positioning member, thereby clamping the positioning member on the frame.

11. The clamping mechanism of claim 10, wherein the frame comprises a fixing portion and a receiving portion connected to the fixing portion, the frame defines a positioning groove for partially receiving the positioning member.

12. The clamping mechanism of claim 10, wherein the receiving portion comprises a first side plate, two second side plates substantially perpendicularly connected to opposite ends of the first side plate, and a third side plate connecting the second side plates, and parallel to the first side plate, and the third side plate is shorter than the first side plate.

13. The clamping mechanism of claim 10, wherein the operating assembly comprises a pivot shaft rotatably connected to the frame, a main body rotatably sleeved on the pivot shaft, a rotatable shaft extending through the main body, and an operating pole connected to the main body.

14. The clamping mechanism of claim 13, wherein the main body comprises a first part and a second part, the second part connected to the first part at a slant, the pivot shaft and the rotatable shaft extend through the first part, and the operating pole is fixed to the second part.

15. The clamping mechanism of claim 13, wherein the operating assembly further comprises two connecting pieces positioned on opposite sides of the frame, and each connecting piece connects the resisting member to the rotatable shaft.

16. The clamping mechanism of claim 15, wherein the operating assembly further comprises two elastic members positioned on opposite sides of the frame, and each elastic member connects the resisting member to the rotatable shaft.

17. The clamping mechanism of claim 16, wherein the elastic members are a plurality of tension springs.

18. The clamping mechanism of claim 10, wherein the resisting member is substantially cylindrical.
